(19) United States
(12) Patent Application Publication
(10) Pub. No.: US 2016/0048583 A1
(43) Pub. Date: Feb. 18, 2016

(54) SYSTEMS AND METHODS FOR AUTOMATICALLY ACTIVATING REACTIVE RESPONSES WITHIN LIVE OR STORED VIDEO, AUDIO OR TEXTUAL CONTENT

(71) Applicant: SKIPSTONE LLC, Ann Arbor, MI (US)

(72) Inventor: Troy Ontko, Ann Arbor, MI (US)

(21) Appl. No.: 14/424,077

(22) PCT Filed: Nov. 6, 2014
(86) PCT No.: PCT/US14/64345

§ 371 Date: Feb. 26, 2015

Related U.S. Application Data
(60) Provisional application No. 61/901,193, filed on Nov. 7, 2013.

(51) Int. Cl. G06F 17/30; G06F 3/0484; G06F 3/0482

(52) U.S. Cl. CPC G06F 17/30654; G06F 3/0482; G06F 3/04842; G06F 17/30696; G06F 17/30864

(57) ABSTRACT

Methods and associated apparatus automatically activate ‘reactive’ responses within live or stored video, audio or textual content delivery. The invention allows participants to engage in a manner that closely approximates a live interaction with a “subject matter expert” of a product or service or with the presenter of a meeting or course. The various embodiments, including Demo, Training and Meeting applications, all involve admin-user(s) with a high degree of control over the above-mentioned media assets. The embodiments also involve end-users, also referred to as “viewers,” who may view and ask questions relating to the product, service or presentation showcased in the video, audio, or other media assets.

### REFERENCE TO RELATED APPLICATION

This application claims priority from U.S. Provisional Patent Application Ser. No. 61/901,193, filed Nov. 7, 2013, the entire content of which is incorporated herein by reference.

### FIELD OF THE INVENTION

This invention relates generally to interactive content presentation and, in particular, to computer software applications that automate audience question and answer (Q&A) participation using query lookup for pre-recorded responses and responses from experts and original presenters, including ad hoc questions.

### BACKGROUND OF THE INVENTION

With the proliferation of websites that purport to provide answers to questions about products and services, it is becoming increasingly difficult to determine the authenticity (i.e., “is it from the originator of the product or service?”), veracity (“is it true?”) and validity (“is it still current/up-to-date?”) of the available, sometimes conflicting, information. Moreover, with the increasing trend towards a distributed and remote workforce it is difficult to disseminate information, meetings and training content except in a passive and “review” mode.

There have been many attempts to somehow ‘automate’ the Q&A process. U.S. Pat. No. 5,870,755 is directed to creating a database for facilitating a “synthetic interview.” Generated questions and responses to the questions are recorded. The questions and responses are expanded with semantic information, and inverted indices are created for the semantic expansions of the responses, the questions, and the transcripts of the responses and questions to improve retrieval of the recorded responses. A method is also disclosed for creating a database to generate a synthetic interview from existing material.

U.S. Pat. Nos. 6,028,601 and 6,243,090 reside in the creation of a FAQ (Frequently Asked Question) link between user questions and answers. A user enters input, or a question in natural language form, and information is retrieved. A questions database is coupled to the input interface which contains questions that are comparable to the input, and which the source retrieves in response to an input. An information source is coupled to the input interface which contains information that is relevant to retrieved questions. Information is ranked according to the entered query. A user's question is stored and linked to answers in the questions database. Users may add and link new questions which are not already stored in the questions database.

U.S. Pat. No. 6,288,753 concerns live, interactive distance learning. The system is based on an interactive, Internet videoconferencing multicast operation which utilizes a video production studio with a live instructor giving lectures in real-time to multiple participating students. A software screen is used as a background with the instructor being able to literally point to areas of the screen which are being discussed. The instructor has a set of monitors in the studio which allow him/her to see the students on-location. In this fashion, the students can see at their computer screens the instructor “walking” around their computer screen pointing at various items in the screen.

Published U.S. Patent Application Nos. 2002/0072974 and 2002/0078700 make use of “live experts.” The system supports existing merchants and malls to provide customers with access to merchandise and sales assistants over a communication network to display items and to provide expert information on products. The shopping experience is enhanced with tokens to allow ease of shopping and checkout. Items purchased that need installation or service or supported by accessing live experts. Direct connection to service providers is available over the network. If a shopper does not find the desired merchandise they are referred to another merchant who has the product and the referring merchants receives a commission or other consideration.

Published U.S. Patent Application No. 2008/0259155 relates to customer assistance through online commercial transactions utilizing a mix of live and pre-recorded video presentations and interactions. A display window in the customer interface displays a live video feed of operator and a pre-recorded video clip of an operator. The interaction between the customer and the operator may include live text chat, live video conference, pre-recorded video messages or third party intervention. A recall device may play a prerecorded video clip of an answer to a frequently asked question, a greeting previously recorded by the operator, an answer previously recorded by said operator and an answer previously recorded by a third party.

U.S. Pat. No. 7,702,508 describes natural language processing of query answers. Candidate answers responsive to a user query are analyzed using a natural language engine to determine appropriate answers from an electronic database. The system and methods are useful for Internet based search engines, as well as distributed speech recognition systems such as a client-server system. The latter are typically implemented on an intranet or over the Internet based on user queries at his/her computer, a PDA, or a workstation using a speech input interface.

U.S. Pat. No. 8,358,772 relates to directing a caller through an interactive voice response (IVR) system, and making use of prerecorded precategorized scripts. The process involves manually guiding inbound callers through an IVR system, then sequentially playing prerecorded, precategorized scripts, or audio dialogs, to the caller in accordance with the steps of a sales method governing the categorization of the scripts. Certain embodiments of the present invention include substitute means of collecting, conferencing, routing, and managing inbound callers in and out of IVR platforms.

Published U.S. Application No. 2013/0246327 resides in an expert answer platform that delivers expert answers to crowd-sourced user questions. Using the system, experts may provide answers (e.g., in the form of video-blogs) to such crowd-sourced user questions. The system may also serve as a marketing platform for experts. Experts may post entries on topical issues in their area of expertise, build a following among the public, promote the expert's books and/or research, obtain funding for their activities, and/or the like.

According to Published U.S. Application No. 2014/0013230, an interactive video response platform creates a seamless video playback experience by receiving stimulus from an audience member, receiving a first video content from a content producer on the interactive video response platform, and displaying video content in response to the stimulus on the interactive video response platform. The seamless video playback can include a transition between video content clips, such that there is little or no discernable end to one video clip before another begins. The seamless video playback can also include multiple types of segments that can be displayed, including those that can be played while awaiting stimulus from the audience member.

Published U.S. Application 2014/0081953 is directed to providing answers in an on-line customer support site. The method includes receiving a first question from a user, determining first results from a knowledge base, determining second results from a community, determining third results from an agent, and displaying the first results, the second results, and the third results responsive to the first question in a single, integrated feed.

An example method disclosed in Published U.S. Application 2014/0161416 includes receiving a video bitstream in a network environment; detecting a question in a decoded audio portion of a video bitstream; and marking a segment of the video bitstream with a tag. The tag may correspond to a location of the question in the video bitstream, and can facilitate consumption of the video bitstream. The method can further include detecting keywords in the question, and combining the keywords to determine a content of the question. In specific embodiments, the method can also include receiving the question and a corresponding answer from a user interaction, crowdsourcing the question by a plurality of users, counting a number of questions in the video bitstream and other features.

### SUMMARY OF THE INVENTION

This invention provides methods and associated apparatus for automatically activating ‘reactive’ responses within live or stored video, audio or textual content delivery. In its various embodiments, the invention allows participants to engage in a manner that closely approximates a live interaction with a “subject matter expert” of a product or service or with the presenter of a meeting or course.

Three embodiments are disclosed, including Demo, Training and Meeting applications. All embodiments involve admin-user(s) with a high degree of control over the above-mentioned media assets. All embodiments also involve end-users, also referred to as “viewers,” who may view and ask questions relating to the product, service or presentation showcased in the video, audio, or other media assets. End-users may not upload or delete the media assets.

In all embodiments, the content may be delivered in the form of video, audio or text, or combinations thereof, with user inputs and responses being received by these and other (i.e., text messages, email) modalities. In video and audio implementations, control functions may at least include play, pause, slow replay, zoom features or other capabilities. Product descriptions and product comparisons are two possible uses.

In a general Demo video example, an administrative user may record videos or audio or HTML content that (1) answer questions anticipated to be asked upon viewing the content; and (2) provide more detail or in-depth information; for example, a detailed description of a particular section of a particular product or other demonstration. As the end-user watches the demo, training or meeting, questions may be posed by the end-user and answered by the application from a repository of pre-recorded questions. If the end-user poses a non-existent (i.e., ad hoc) question, the application arranges for the question to be answered by a subject matter expert or the original presenter as the case may be. Other viewers of the demo may see questions and answers also accumulated in the repository from previous viewers' ad hoc questions, such that when a viewer views the same video (as tracked by the specific/target product, meeting or presentation), they could see previous ad hoc questions and answers from the viewers that watched the same demo or presentation earlier. Any question-answer in the repository may have an associated time-stamp that enables viewers to view it at the appropriate time while viewing the video. This makes the invention a repository of an ever-expanding, dynamic and authoritative information about a product, service or presentation.

Depending on the environment, the invention enables end users (viewers), to be authenticated. For example an end-user viewing the demo embodiment does not require authentication. In other situations, such as in the meeting embodiment (for the meeting-by-invitation-only case) the invention requires that the user be authenticated. This has implications for response analytics described later.

For an authenticated end-user, the invention gathers and persists response analytics in the database. For an unauthenticated end-user, the invention implements a more limited form of persistence in the end-user's computer's cookies. In either case, the invention implements enhancements including response analytics, which allow for the tracking of the viewer watching the video to include, but not be limited to, the length of the viewing, what part of the video was replayed, and what FAQs were reviewed. In conjunction with a Response Analytics system enhancement, a tailored advertising program may then be created unique to an individual viewer.

In accordance with the Demo embodiment of the invention, additional user experience personalization capabilities allow demos to be categorized and cross-referenced by feature/function and budgetary considerations of the viewer (multidimensional). This would lead the viewer from looking at a general product demo to focusing on what product, with what desired features, the viewer could afford. Moreover, a further refinement offered by the invention is predictive and tailored navigation through the (video) asset based on past navigation patterns. An enhanced video platform, based on view tracking and analytics, may be used to re-sequence the video to focus on the viewer interests evident from the video viewing (real-time tailoring of the demo to the viewer's viewing of the demo). As an example, if the viewer is looking at a new car video and seems to focus on fuel economy, the rest of the video might emphasize that particular feature.

In accordance with the Training embodiment of the invention, a user creates video, audio or textual content involving a training scenario. The core market would be training that is repeatable and constantly needed, for example, the training of new employees in product selling. The interactive training suite would be targeted at sales and customer service situations. Training videos may be designed for interactive training with role playing components. For example, the application may incorporate 2-way interactivity, with the trainee reacting to others simulating a real life scenario. The trainee may also be video recorded while reacting to the video simulations. By way of example, a video might present a sales scenario in a simulated environment. A sales trainee would view a prospective customer (i.e., a video of a real person acting as a customer in a sales setting). The trainee would respond to the video prompts simulating the specific sales situation. The simulation and responses would be recorded.

In accordance with the Training embodiment of the invention, upon completion of a specific scenario, the video simulation would be played back and reviewed, focusing on what was done correctly or incorrectly. The trainee could then view videos of the correct response for each step in the scenario. The sales template would preferably include multiple scenarios, with multiple outcomes and video interactions with many different types of prospective customers. Overall, the system would be designed to create segmented modules, with potential course-type offerings being anticipated with the user defining the requirements.

In accordance with a “Meeting” embodiment of the invention, other user participants may see questions and answers from other viewers of a meeting or presentation. For example, when a viewer or viewers log into the same video presentation (as tracked by presentation or meeting id), they could see the other viewers' questions and answers including viewers that watched the video earlier or are currently watching it. Early viewers will be provided with or have the opportunity to review the questions and answers from later viewing sessions of the same presentation or meeting. These “collaborative” meetings may also be activated by emailing the video to others, or by one member forwarding the presentation to another. Other mechanisms of activation are possible.

### BRIEF DESCRIPTION OF THE DRAWINGS

FIG. 1 shows the core system common to all the embodiments;

FIG. 2 shows the steps common to all embodiments for a typical end-user use case;

FIG. 3 shows a highly simplified representation of a user interface common to all embodiments for watching a video in this invention;

FIG. 4 shows a highly simplified representation of a user interface common to all embodiments for asking questions and receiving responses;

FIG. 5 shows the high-level view of the Demo embodiment;

FIG. 6 shows the high-level view of the Training embodiment; and

FIG. 7 shows the high-level view of the Meeting embodiment.

### DETAILED DESCRIPTION OF THE INVENTION

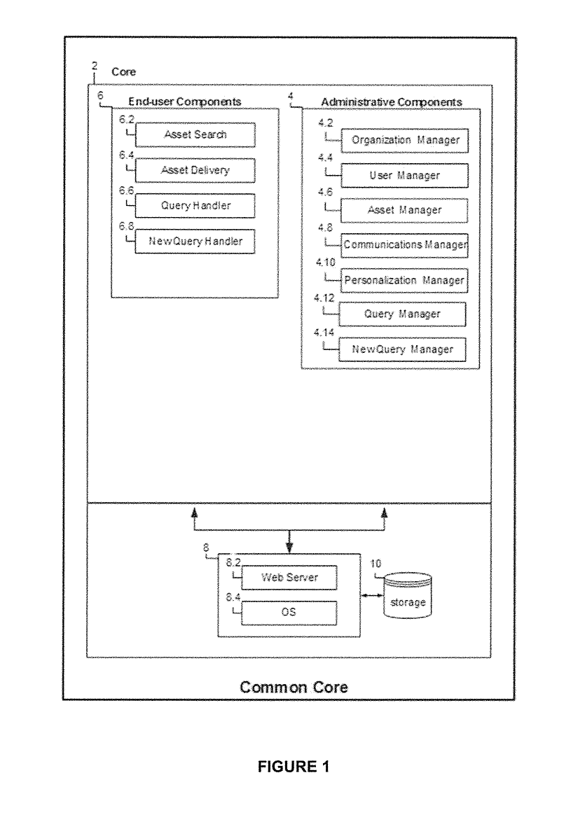

This invention resides in methods and associated apparatus for automatically activating ‘reactive’ responses within live or stored video, audio or textual content. There are multiple embodiments of the invention, including a Demo Application, a Training Application, and a Meeting Application. Each of these applications are described in detail herein. All three embodiments share a number of common components and capabilities. Each embodiment uses the core components by either adapting them or adding embodiment-specific components to them. FIG. 1 shows the core system 2 common to all the embodiments. It consists of 4 major sub-systems, the Administrative Components 4, the End-user Components 6, the underlying Computer System 8, and the Storage Component 10.
1. The Administrative Components 4 include the following components:
   Organization Manager (4.2) manages partner organization data (contact information, other settings),
   User Manager (4.4) manages authenticated users,
   Asset Manager (4.6), enables the administrative user to upload assets (video/audio/text and video transcription for captions),
   Communications Manager (4.8) enables the administrative user to manage email communications between the end user and the application,
   Personalization Manager (4.10) automates the gathering and organizing of the end-user's usage patterns and preferences,
   Query Manager (4.12) enables the administrative user to create/edit questions and answers (and any time stamps) associated with the product, service or presentation
   New Query Manager (4.14) enables the administrative user to respond to new (ad hoc) questions (that are not yet present) from the end-user
2. End-user Components 6 include the following components:
   Asset Search (6.2), enables search of a video or other media asset from the collection of assets
   Asset Delivery (6.4), enables the viewing of a selected video and experiencing all assets associated with it (text, audio and secondary videos) including any video transcriptions as video captions,
   Query Handler (6.6), enables the end-user to ask questions and receiving responses to existing questions.
   New Query Handler (6.8) enables the end-user to pose a new (non-existent) question and receive the response.
3. (8) is the underlying server-side operating system 8.2 and Web Server 8.4.
4. (10) is the storage and access of the actual assets and user, organization, assets, question-answer records.

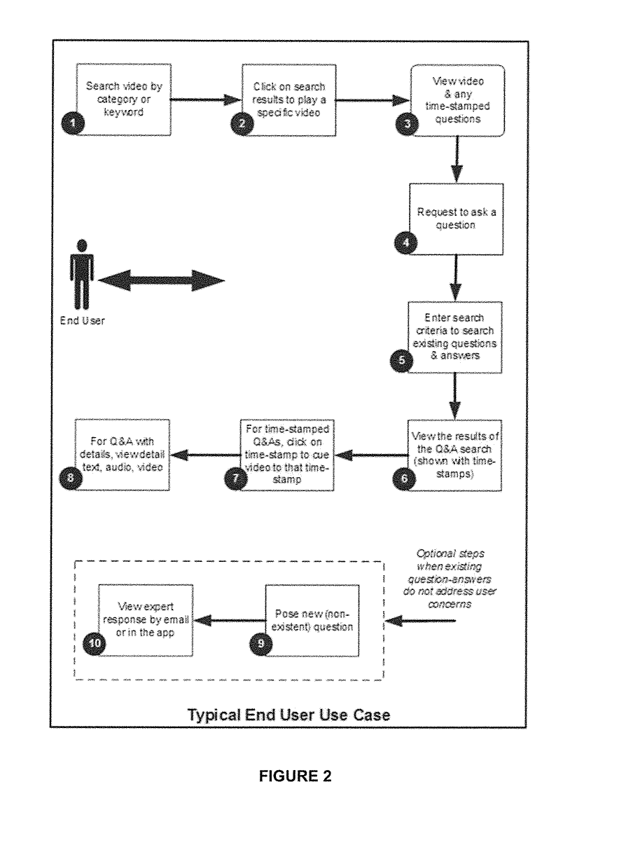

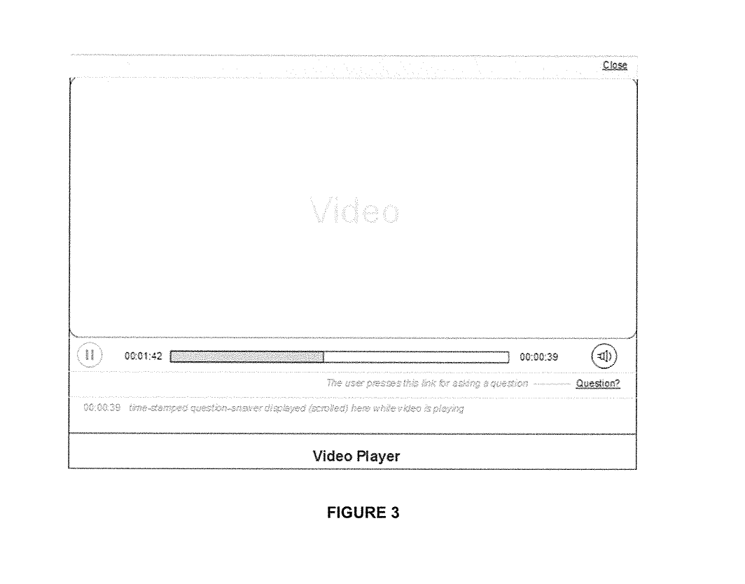

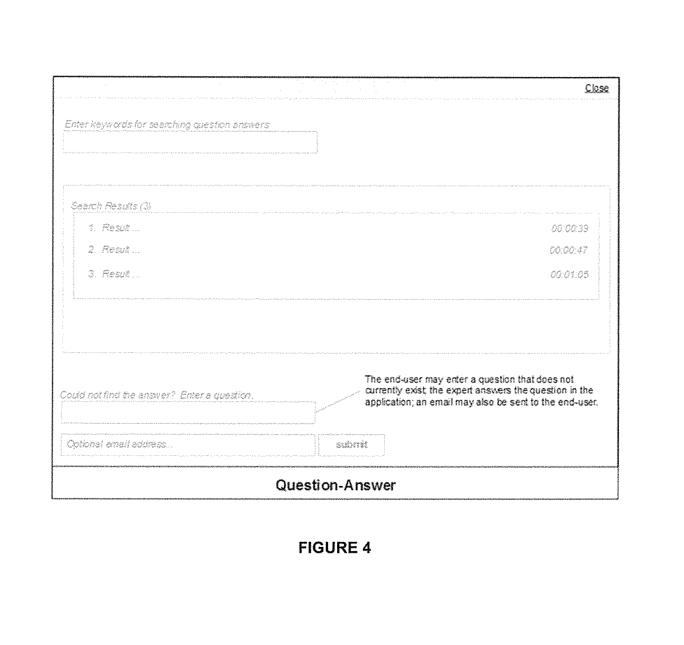

FIG. 2 shows the steps common to all embodiments for a typical end-user looking for an answer to questions about a video. The steps are numbered sequentially to show the order in which they are typically executed.
1. User searches for the video of interest
2. User plays video (a video player window appears FIG. 3) with captions, if any
3. User views video with any time-stamped question-answers below video frame
4. User requests to ask a question (FIG. 4)
5. User searches for question-answer
6. User views desired question-answer from search results
7. Optionally, if question-answer is time-stamped, user cues video to that position
8. If question-answer has details, user views details
9. Optionally, user poses a new (non-existent) question to expert
10. User views expert response

FIG. 3 shows the video player common to all embodiments. The video player shows a video frame, video controls and time-stamped question-answer for that point in the video.

FIG. 4 shows the question-answer search dialog common to all embodiments. The user can search for the question-answer in the existing repository of question-answers for that video. If the user feels that the requisite answer is not found, they can pose a new question. The invention directs the question to the video owner's experts. The user may find the expert answer later in the application or in their email.

### ‘Demo’ Embodiment

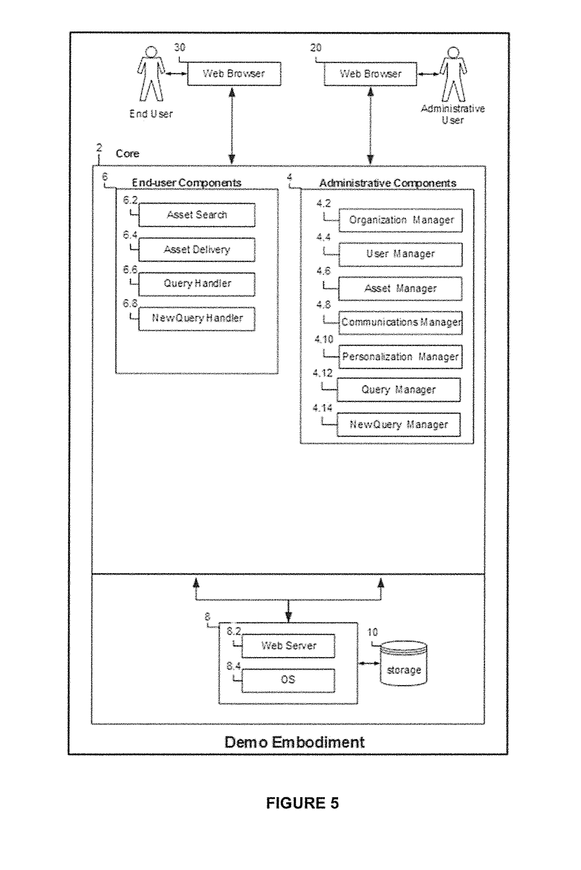

FIG. 5 shows the high-level view of the Demo embodiment. The Demo embodiment includes the Core components and the following additional components:
20 depicts the administrative-user accessing the Demo embodiment from a web browser.
30 depicts the end-user accessing the Demo embodiment from a web browser.

The Demo embodiment (application) enables an organization to deliver a comprehensive collection of multimedia information to demonstrate a product or service. The end user experiences the application as a personalized, interactive, and dynamically growing source of information about the product or service. The application organizes and supplements an organization's original multimedia content (video, audio/voice or text), but without necessarily modifying the original content. The application may be used for product descriptions, repair procedures, service offerings, software solutions, and other presentations. Typically a creator/editor adds and updates anticipated questions and answers to the original content. A user may search the Demo by category or keyword, with the application providing answers to users' questions from the previously stored question-answers. The application enables the creator/editor to respond to user questions that have not yet ‘been asked,’ adding new responses to any existing ones. The answers or responses may be delivered in various ways as described herein, including electronic mail, etc.

Overall, the Demo application personalizes the user experience based on user preferences and usage patterns by displaying convenient access to related products and services. The application personalizes the user experience by offering alternative, relevant navigation paths based on past usage patterns and interests.

The Demo application also offers administrative interfaces that enables the administrator to perform various features and functions, including:
Manage partner organization accounts (super-user). An administrative user with an appropriate role (super-admin) manages an organization record in the application. An organization is a partner organization that has established a relationship with the provider, and intends to add media (video, audio, etc.) that describes their product offerings. This role adds organization-related information that allows the application to identify the organization (name, email address and its authorized users that may also perform specific authorized operations). This role may also may add, edit and delete organization records from the application database as needed.
Manage role-based authentication/authorization for users (roles: super-admin, admin, editor, end user). An authorized user may perform very specific functions based on the role(s) assigned to them by the application (as per the super-admin). The user is also assigned an organization (typically the organization they are associated with). The actions that a user may perform are precisely circumscribed by the intersection of the assigned role and the assigned organization so a specific user may only perform those roles for the organization(s) that are associated with them. It is possible for a user to have multiple roles in multiple organizations. Roles are hierarchical; a “higher” role subsumes the permissions of the “lower” ones within a designated organization.
Upload the primary multimedia asset (e.g. video). An administrative user with an appropriate role (editor role or higher) in a partner organization may upload video, audio or text asset(s) that describes a product or service offering. The assets must closely follow the format, encoding, etc. prescribed by the application. The application places the video in the application's content repository designated for the organization. The application records asset information and associated data in the application database. The application does not directly modify the contents of the asset per se.
Manage keywords and categories for the primary asset to enable searching for the primary asset. The application offers an interface that allows a partner organization's user with an appropriate role (editor role or higher) in a partner organization to tag the (video, audio, HTML) asset by entering keywords associated with the video and its contents in order to allow the asset to be searched by an end-user (viewer). The application also offers an interface that allows a user in this role to broadly categorize the uploaded asset and its contents using a pre-defined taxonomy offered by the application. (e.g. search a vehicle video by “brand” and “type”). This capability offers another way for end users to search for a product asset.
Designate featured products or services for use in other sites. The application offers an interface that allows an internal user with an appropriate role (super-admin) to designate selected videos for selected partner organizations as “featured” videos. This interface also generates a list of featured videos. The list can be used to load the thumbnails as links (to the actual video) on the provider's website or on a partner website as a premium offering that showcases these offerings.
Create/Edit a collection of textual questions and answers that address the customer's concerns and queries about the product or service. The application offers an interface that allows a partner organization's user with an appropriate role (editor role or higher) to create textual questions and answers for frequently asked questions about the product. The editor is required to tag each question with one or more keywords in order to make the question-answer about the offering searchable by the end-user (viewer). The question, answer and tag are saved as asset “metadata” in the application database.
Create/Edit assets containing more detailed information (secondary assets) as text, audio and video for a question. The application offers an interface that allows a partner organization's user with an appropriate role (editor role or higher) to optionally upload secondary assets that contain more detailed information about a question's answer. This detailed information may be HTML text, audio, or video. As in the case of the primary video, the application enables the editor to tag the secondary assets with keywords in order to include the answer details in the end-user's search for answers.

Create/Edit a time-stamp if it is relevant to a specific point in the primary asset (video or audio) for a question. The application offers an interface that allows a partner organization's user with an appropriate role (editor role or higher) to associate a time-stamp with a question-answer if the question-answer is relevant to a specific point in the video. This capability allows the application to display the time-stamped question-answer at the appropriate time in the video while it is playing.
Manage any new questions posed by end user. As explained earlier, the application allows the end-user (viewer) to search for questions and answers about a video. The application performs the search in the existing collection of question-answers, including any secondary assets. Furthermore, if the viewer is unable to have their question answered in the existing collection of question-answers, the application allows the viewer to “pose” a new question to the application and, optionally, provide an email address in order receive a personalized response from the “application.” The application saves the posed question in the application. On viewing the list of new, posed questions in the application, the organization's editor uses the application to initiate a workflow in order to curate the question. The editor determines if the question is in one of the following categories:
“already exists in current collection”,
“is relevant, does not already exist, and must be added to the current collection of question-answers”
“is irrelevant or inappropriate” and must, therefore, be rejected

If the answer does not already exist (category 2 above), the application also offers an interface to the editor in order to create a new question-answer, thus adding to the collection of question-answers for the video. The application allows the editor to specify the resolution of the curation process, thus completing the curation workflow.

If the user had entered their email address, the application automatically also sends the appropriate resolution to the posing end-user. In the case of newly added question-answers, the end-user may also return to the application at any time in order to view the (newly posted) answer. The question-answer is now available to all users who view the product or service video and becomes part of the repository of question-answers for the product or service.
Gather, analyze and report user preferences and usage patterns. The application gathers user preferences and usage patterns based on the categories of the videos viewed, the questions asked and the (temporal) points in the video viewed/reviewed.

Again, the Demo application allows the end user to browse the primary asset (e.g. video, audio, text) that describes and promotes a product or service. The web application offers interfaces that enables the end user to perform the following functions:

Use text, voice or both modes for all queries and responses. The application enables the end-user to perform all queries to search video, play video and find answers to questions either as text or voice. The application simultaneously shows the text version of all voice requests and responses.

Search for a primary asset for product (e.g. video, audio) by keyword or category. The end-user may search for a video either by keywords or by category. The application displays the results of the search as video records that match the user-entered inputs. The user may play any of the videos from the video results.

Experience (view, listen to, read) the primary asset in a web browser. The end-user plays the video and performs all operations listed above in a web browser. Any video transcriptions are also viewable as captions during playback.

View any time-stamped questions displayed at the appropriate time in the video or audio. The application displays (in a scrolling view) any time-stamped question-answer at the appropriate time in the video while it is playing.

Search for a question-answer by keyword(s) or view all question-answers for the product or service. The application allows the end-user to search for question-answers by keywords, or in the case of voice inputs, using spoken phrases or sentences containing the keywords.

View/listen to/read question-answers from the search results—with optional time-stamps. The application displays the question-answer search results containing the question, answer and any time-stamp associated with the question.

View more detailed information (in secondary assets) for a question-answer as text, audio or video. The application displays links to any details (text, audio, video) that may be associated with an answer. Pressing on the appropriate link displays the contents of the details as text, audio or video.

Cue video/audio to the time-stamp associated with a time-stamped question. The application cues the video to the appropriate time-stamp within the video when the end-user presses on a question-answer time-stamp link.

Pose a new question that is not in the current collection of questions. The application allows the end-user to pose a new question if the user is not satisfied with the search results of their question-answer search. The end-user may also, optionally enter an email address in order to receive a personalized response as described earlier.

Receive an email answer for the newly posed question. The application sends an automated email response to the end-user who poses a question as described earlier.

Access related products and services. The application personalizes the user experience by offering other related product and service links based on the user's viewing habits.

Have a personalized experience of a product demo by following navigation paths based on past usage patterns and interests. When possible, the application offers navigation alternatives within the video that closely match the viewer's preferences and usage patterns.

### Training Embodiment

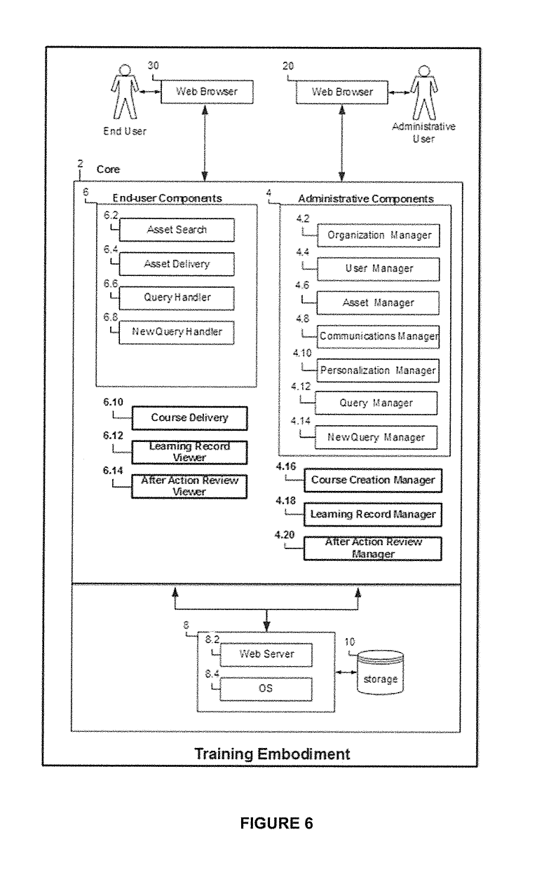

FIG. 6 shows the high-level view of the Training embodiment. The Training embodiment builds upon the Core components by adding the following components.
20 depicts the administrative-user accessing the Training embodiment from a web browser.
30 depicts the end-user accessing the Training embodiment from a web browser.
The figure shows the following additional components that support the administrative side:
   Course Creation Manager (4.16) enables course content creation, scoring criteria and conditional navigation rules (e.g. if trainee selects answer A.1, take trainee to question B; otherwise go to question C.)
   Learning Record Manager (4.18) enables access and control of trainee records & scores,
   After Action Review (4.20) enables a review of the trainee's responses
The figure shows the following additional components that support the user side:
Course Delivery (6.10) enables a trainee to go through the course offering (i.e. to take the course)
Learning Record Viewer (6.12) enables the trainee to review their training records and scores.
After Action Review (6.14) enables the trainee to review (with or without the instructor) their performance and “expected” responses.

The Training embodiment (application) facilitates an interactive training environment centered around a pre-recorded or live training presentation. The end user experiences the application as a repeatable, personalized, and interactive source of training. The application organizes and supplements the original presentation's multimedia content (video, audio or text), but does not necessarily modify the original content. As with the other embodiments described herein, the user interaction may be text, voice or both.

The Training application supports a variety of uses, including training for target market sales, customer service, and so forth. The user may search for a presentation by category or keyword, and can specify or be assigned training goals to receive a customized session with appropriate scenarios or other content. The application engages a trainee with questions and scenarios from real-life situations, with the results being “scorable” and reviewable. Application segments may be divided into sessions with graduated modules.

The Training application offers administrative interfaces that enable the training administrator to perform the following feature/functions:
Manage organizational accounts (super-user); same as demo embodiment.
Manage administrative user accounts and roles (trainee, editor, reviewer, admin, super-admin). The training application offers administrator user accounts management capabilities as described in the demo embodiment. The training embodiment has an added role (reviewer). A user in the reviewer role reviews and evaluates the trainee's responses and performance.
Manage trainee account, history & performance for Learning Record System (LRS). The training application embodiment implements a Learning Record System that manages the training records of trainees. The LRS includes records containing trainee identification, training sessions with date-time and length, performance scores and reviewer identification.
Manage After Action Review (AAR) system. The training application embodiment implements an After Action Review system to facilitate the review of a training session. The AAR system enables the reviewer(s) and trainee to review the training session, jointly or separately, with full control (play, pause, etc.) including marking and commenting capabilities for the reviewer.
Create/Edit training presentation (may be open, closed—i.e., by invitation only, passive—i.e., no tests,). The training application embodiment provides an interface that allows an appropriate role (admin) to create/edit training presentations with selected attributes including “open to anyone” or “open to selected group,” “is test-free” or “requires testing.”
Manage keywords and categories to enable searching training videos. Same as in demo embodiment.
Define available training goals and scenarios for a course offering. The training application embodiment provides an interface that allows an appropriate role (admin) to specify a training scenario (either new or selected from a list of pre-defined scenarios) and the goal(s) of the scenario.
Designate featured training videos for use in other sites. Same as in demo embodiment.
Manage session scoring setup and performance reporting. The training application embodiment provides an interface that allows the appropriate role (admin) to specify the scoring criteria and evaluation targets for a pass/fail or for a graduated scoring system (e.g. 1-10 or A-F). The application also provides reports of past performance records of trainees.
Manage the training session workflow and sequencing (that depends on trainee responses). The training application embodiment provides an interface that allows the appropriate role (admin) to create/edit the sequence associated with a trainee response (e.g. if trainee gives response “A1” to question “Q1”, navigate to question “Q7”; otherwise navigate to question “Q11”).
Upload the primary multimedia asset (e.g. video, audio) containing the training. Same as in demo embodiment.
Manage invitations to trainee participants (email). The training application embodiment provides an interface that allows the appropriate role (admin) to send email invitations to a training session.
Create/Edit test questions and scenarios with search keywords. The training application embodiment provides an interface that allows the appropriate role to (admin) to create and edit test scenarios for a training presentation together with associated questions and their keywords to facilitate search.
Create/Edit “correct” responses or actions (could be multiple). The training application embodiment provides an interface that allows the appropriate role (admin) to create/edit answers to questions together with associated scores values.
Upload secondary assets (video, audio, text) for more detailed explanations of questions or scenarios. Same as in demo embodiment.
Create/Edit a time-stamp if it is relevant to a specific point in the primary asset (video or audio) for a question or scenario. Same as in demo embodiment.
Manage relationships between training presentations. The training application embodiment provides an interface that allows the appropriate role to (admin) to define training presentations that are related to other presentations.

The Training application allows the end user to browse the primary asset (e.g. video, audio, text). The web application offers interfaces that enables the end user to perform the following functions:
Use text, voice or both modes for all queries and responses. Same as in demo embodiment.
Search for a primary asset (e.g. video, audio) for a presentation by keyword or category. Same as in demo embodiment.
Specify training goals or use assigned goals. The training application embodiment provides an interface that allows the appropriate role (end-user/trainee) to specify the goals of the training session selected from a list of goals associated with a presentation. The trainee may also use all the pre-defined goals associated with the presentation.
Experience (view, listen to, read) the training session in a web browser. The training application embodiment provides an interface that allows the appropriate role (end-user/trainee) to experience the presentation.
View/listen to/read more detailed information (in secondary assets) for a question or scenario as video, audio or text. Same as in demo embodiment.
Experience the test/review for the session by responding to questions or scenarios. The training application embodiment provides an interface that allows the appropriate role (end-user/trainee) to take any test that may be associated with a training presentation.
View training history/records from the Learning record System (LRS). The training application embodiment provides an interface that allows authorized users to view the trainee's own training history, scores, training plans, etc.
Participate in the After Action Review (AAR)—review trainees responses and expected responses. The training application embodiment provides an interface that allows the appropriate role (end-user/trainee) to participate in a live AAR with a reviewer or to experience a previously performed AAR of the trainee's session. This applies to a presentation that is of the “testing” (active presentation) type.
View links to other related training sessions. The training application embodiment provides an interface that allows a user to view a list of presentations authorized for the user.

### Meeting Embodiment

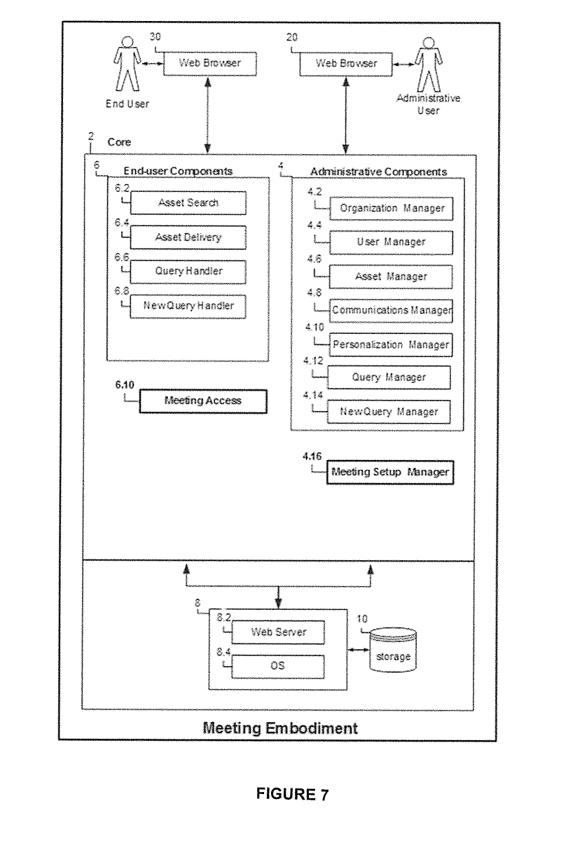

FIG. 7 shows the high-level view of the Meeting embodiment. The Meeting embodiment builds upon the Core components by adding the following components.
20 depicts the administrative-user accessing the Meeting embodiment from a web browser.
30 depicts the end-user accessing the Meeting embodiment from a web browser
The figure shows the following additional components that support the administrative side:
   Meeting Setup Manager (4.16) enables meeting setup including date-time, meeting type (open, by-invitation, one-time, repeatable), participant setup including the roles and permission of the participants (passive, active, question-answer access control)
The figure shows the following additional components that support the user side:
   Meeting Access (6.10) enables a meeting participant to access the meeting within the pre-defined parameters setup for the participant

The Meeting embodiment (application) facilitates an interactive meeting environment centered around a pre-recorded or live presentation. The end user experiences the application as a repeatable, personalized, interactive and dynamically growing source of information centered around the original presentation.

The application organizes and supplements the original presentation's multimedia content (video, audio or text), but does not necessarily modify the original content. As with the other embodiments described herein, the user interaction may be text, voice or both. The participant(s) view/hear the original presentation (audio/video/text) either privately or in a group session that may be co-located or distributed.

Participants of the Meeting embodiment may pose questions and receive answers from existing questions already in the application. The presenter may also respond to user questions that are not already present; these are added to the existing questions, and may also be emailed to participants. Participants may view other participants' question-answers (if authorized). A user may also email a meeting link to another user if authorized to do so.

The Meeting application offers administrative interfaces that enables the meeting owner/organizer to perform the following feature/functions:
Manage organizational accounts (super-user). Same as in other embodiments.
Manage administrative user accounts and roles. Same as in other embodiments.
Create/Edit meeting event (may be open, closed—by invitation only, passive—no comments, active—default). Same as in Training embodiment.
Upload the primary multimedia asset (e.g. video, audio, text) containing the original presentation. Same as in other embodiments.
Manage keywords and categories to enable searching for the meeting/presentation. Same as in other embodiments.
Designate featured meetings for use in other sites. Same as in other embodiments.
Manage invitations to participants (email). Same as in Training embodiment.
Manage participant privileges (passive participant, active participant, facilitator, convener) dynamically on a per-event-basis. The training application embodiment provides an interface that allows the appropriate role (super-admin) to assign a role to participants. The default role is “passive participant”; a user in this role may only experience the presentation as an “onlooker”. An active participant may ask questions and view other participant question-answers unless the originator of a question has restricted the visibility of the question-answer. The “convener” role is purely administrative (invite people and assign them roles). A user in the “facilitator” role ensures that the meeting is conducted in an orderly, fair and civil manner and therefore has privileges to exercise “censure”.
Create/Edit a collection of questions and answers that address the participants' concerns and queries about the presentation topic. Same as in other embodiments.
Create/Edit links to more detailed information (secondary assets) as text, audio and video for a question. Same as in other embodiments.
Upload secondary assets (video, audio, text) for question-answers. Same as in other embodiments.
Create/Edit a time-stamp if it is relevant to a specific point in the primary asset (video or audio) for a question. Same as in other embodiments.
Create/Edit keywords for questions to enable searching existing question-answers. Same as in other embodiments.
Manage question status (closed—no more comments, hidden). The meeting application embodiment provides an interface that allows an administrative user to manage the status of questions.
Manage any new questions posed by end user. Same as in other embodiments.
Curate a new question posed by an end user as: Same as in other embodiments.
Add the new posed question-answer to the accumulated question-answers and optionally email it to the original questioner. Same as in other embodiments.

The Meeting Application allows the end user to browse the primary asset (e.g. video, audio, text), with interfaces that enable the end user to perform at least the following functions:
Use text, voice or both modes for all queries and responses. Same as in other embodiments.
Search for a primary asset (e.g. video, audio) for a meeting by keyword or category. Same as in other embodiments.
Experience (view, listen to, read) the primary asset in a web browser. Same as in other embodiments
View any time-stamped questions displayed at the appropriate time in the video or audio. Same as in other embodiments.
Search for a question-answer by keyword(s) or view all question-answers. Same as in other embodiments.
View/listen to/read more detailed information (in secondary assets) for a question-answer as video, audio or text. Same as in other embodiments.
Cue video/audio to the time-stamp associated with a time-stamped question. Same as in other embodiments.
Pose a new question that is not in the current collection of questions. Same as in other embodiments.
Control question-answer visibility to others (who can view posed question-answer). The meeting embodiment of the application allows an active participant with appropriate privileges to control the visibility (to others) of their own questions. Facilitators may perform the same action for any or all participants.
Receive an answer (email/in-meeting) for the newly posed question. Same as in other embodiments.
Send invite (email) to another user (depending on meeting type and authorization).

View links to related meetings; The meeting embodiment of the application allows a user to view (other) meetings related to a meeting by following the links to “related meetings”
Have a personalized experience of a meeting by following navigation paths based on past usage patterns and interests. Same as in other embodiments.

### Television Commercial Embodiment

The invention is applicable to TV commercials as follows. As viewer watches a commercial, an entered command (typed, voice or other) pauses programming, which allows for a question to be asked. The question, in turn, plays an “answer video.” Upon completion of answer video, programming resumes as left off.

Several solutions are possible based on viewer condition. As one example, as the commercial or program plays, a reactive session initialized; current programming is paused utilizing DVR or similar technology. Once the reactive session commences, “Smart TV” software or cable box or other component may connect via the Internet for an online session. The web address for session may be imbedded in background of media. Delivered content, imbedded in the background of media, may include search function and answer media. An option may include search function and web address link to answer media to play from online source.

When the reactive session ends, previous programming resumes were viewer initiated reactive session.

1. A user interactive system, comprising:
a device for delivering primary content to a user;
a memory for storing questions, and answers to the questions, regarding the primary content;
a device for receiving a user question about the primary content;
a computer processor for automatically determining if the user question is related to any of the stored questions; and:
(a) if the user question is related to at least one of the stored questions, delivering the stored answer to that question to the user, and
(b) if the user question is not related to at least one of the stored questions, performing a supplemental operation to analyze the user question or provide an answer to the user question from a source other than the currently stored answers.

2. The system of claim 1, wherein device for delivering the primary content to the user is a video player.

3. The system of claim 1, wherein device for delivering the primary content to the user is an audio player.

4. The system of claim 1, wherein device for delivering the primary content to the user is display screen displaying text.

5. The system of claim 1, wherein the stored answer to the user question provides additional details about the primary content.

6. The system of claim 1, wherein the device for receiving a user question about the primary content includes a display screen with a pull-down menu of frequently asked questions (“FAQs”).

7. The system of claim 1, wherein the device for receiving a user question about the primary content includes a separate communications link to a set of frequently asked questions (“FAQs”).

8. The system of claim 1, wherein the device for receiving a user question about the primary content includes a keyboard or touchscreen for inputting the user question in textual form.

9. The system of claim 1, wherein the device for receiving a user question about the primary content includes voice recognition apparatus for inputting the user question in verbal form.

10. The system of claim 1, wherein the supplemental operation to provide an answer to the user question includes referring the question to an expert for answering.

11. The system of claim 1, wherein a user is provided with questions and answers from previous users receiving the primary content.

12. The system of claim 1, wherein primary content is made available via a private network or an Internet website.

13. The system of claim 1, wherein the primary content includes a product demonstration, description, comparison, enhancement or repair procedure.

14. The system of claim 1, wherein the primary content is related to training.

15. The system of claim 1, wherein the primary content includes a meeting involving a plurality of users.

16. The system of claim 1, wherein the processor is further operative to monitor and store user response analytics including one or more of the following:
the time associated with a user's involvement with the primary content;
what portions of the primary content were reviewed by a user, and
what questions and answers from other users were reviewed.

17. The system of claim 16, wherein the processor is further operative to customize the delivery of the primary content based upon the user analytics.

18. An interactive content delivery method, comprising the steps of:
delivering primary content to a user;
storing questions and answers to the questions regarding the primary content;
receiving a user question about the primary content;
automatically determining if the user question is related to any of the stored questions; and:
(a) if the user question is related to at least one of the stored questions, delivering the stored answer to that question to the user, and
(b) if the user question is not related to at least one of the stored questions, performing a supplemental operation to analyze the user question or provide an answer to the user question from a source other than the currently stored answers.

19. The method of claim 18, wherein the primary content is delivered in video form.

20. The method of claim 18, wherein the primary content is delivered in audio form.

21. The method of claim 18, wherein the primary content is delivered in textual form.

22. The method of claim 18, wherein the stored answer to the user question provides additional details about the primary content.

23. The method of claim 18, including the step of displaying a pull-down menu of frequently asked questions (“FAQs”) for the user.

24. The method of claim 18, including the step of providing a separate communications link to a set of frequently asked questions (“FAQs”) for the user.

25. The method of claim 18, including the step of using a keyboard or touchscreen for inputting the user question in textual form.

26. The method of claim 18, including the step of using voice recognition to input a user question in verbal form.

27. The method of claim 18, including the step of referring the user question to an expert for answering.

28. The method of claim 18, including the step of providing a user with questions and answers from previous users who received the primary content.

29. The method of claim 18, including the step of delivering the primary content via a private network or through an Internet website.

30. The method of claim 18, wherein the primary content includes a product demonstration, description, comparison, enhancement or repair procedure.

31. The method of claim 18, wherein the primary content is related to training.

32. The method of claim 18, wherein the primary content includes a meeting involving a plurality of users.

33. The method of claim 18, including the step of monitoring and storing user response analytics including one or more of the following:
the time associated with a user's involvement with the primary content;
what portions of the primary content were reviewed by a user, and
what questions and answers from other users were reviewed.

34. The method of claim 33, including the step of customizing the delivery of the primary content based upon the user analytics.
